(19) United States
(12) Patent Application Publication
(10) Pub. No.: US 2025/0135756 A1
(43) Pub. Date: May 1, 2025

(54) RECYCLABLE THERMOFORMABLE FILM

(71) Applicant: AMCOR FLEXIBLES NORTH AMERICA, INC., Neenah, WI (US)

(72) Inventors: Megan N. GOODRICH, Neenah, WI (US); Michele C. PAYANT, Oshkosh, WI (US)

(21) Appl. No.: 18/691,413

(22) PCT Filed: Sep. 24, 2021
(86) PCT No.: PCT/US2021/052036

§ 371 Date: Mar. 12, 2024

(51) Int. Cl. B32B 27/08; B32B 27/30; B32B 27/32; B32B 37/15

(52) U.S. Cl. CPC B32B 27/08; B32B 27/306; B32B 27/32; B32B 37/153; B32B 2250/24; B32B 2307/30; B32B 2307/4026; B32B 2307/722; B32B 2323/043; B32B 2329/04; B32B 2331/04

(57) ABSTRACT

A thermoformable multilayer film includes a first film including a first thermoformable polymer and a second film that includes a first dissolvable layer and a first barrier layer. The thermoformable polymer includes a density from 0.88 g/cm3 to 1.40 g/cm3, the first dissolvable layer includes a saponified ethylene-vinyl ester copolymer, the first barrier layer includes a barrier polymer, the first film includes a first surface and a second surface, the first surface includes an exposed surface of the thermoformable multilayer film, and the first dissolvable layer is positioned between the second surface and the first barrier layer.

### TECHNICAL FIELD

This disclosure is related to thermoformable films, recyclable films and rigid packaging components made therefrom. The thermoformable films, recyclable films and rigid packaging components may be recyclable.

### BACKGROUND

Rigid thermoformed containers are often used as packaging components for consumer, industrial or medical products. These packages often contain products that are sensitive to their environment (e.g., food, beverages, liquids, pharmaceuticals, etc.) such that the packaging helps protect the product and extend the shelf-life to a point in time where a consumer can use the product. Many products that are sensitive to their environment include a moisture content from 30% to 100% by weight of the product.

Common polymers used for thermoforming include polystyrene (PS), polyvinyl chloride (PVC), polypropylene (PP) or polyester (PET). For some products, some of these polymers provide acceptable barrier for the product contained in the package, such as PP. For other polymers, such as PET or PS, the resulting films and packaging components often include additional polymers or additives that are chosen to enhance moisture barrier and/or oxygen barrier of the packaging for the contained product.

Global demand for plastic waste reduction and sustainable packaging solutions is on the rise. Thermoformed packaging components, such as cups or trays, often cannot be recycled due to the component including a variety of polymers that provide barrier to prevent the ingress of oxygen and/or moisture into the package.

Recycling is often efficient or may only be possible if the materials in the package are of the same polymer. For example, in many countries, there are current processes in place to collect, sort and recycle packages of a single polymer, for example, HDPE, PET or PP. However, the combination of materials in a packaging film or component (e.g., PET or PP with additional polymers or additives to enhance barrier) can create difficulties when determining how to dispose of the packaging component after use. Further, some of the current processes in place to recover and recycle packaging components restrict the size and volume of the packaging component. In some recycling processes, a packaging component volume larger than 7.5 liters (2 gallons) or a packaging component size smaller than 5 cm (2 in) in 2 dimensions is not acceptable. For example, a packaging component in the form of a liquid creamer cup (e.g., coffee creamer cup, liquid creamer singles, coffee creamer singles) that measures less than 5 cm in each of 2 dimensions cannot be recycled by most current processes whether it is composed of a single polymer or a combination of polymers.

### SUMMARY

Thermoformed components can be used for packaging a wide variety of products including, but not restricted to food, cosmetics, lotions, lawn care products, cleaners/soaps, concentrates, industrial materials, pharmaceuticals, medical supplies, and medical devices. Some thermoformed components may not be recyclable due to the thermoformed component size or volume or due to polymer combinations that do not lend themselves to recovery and recycling processes.

This disclosure relates to thermoformable multilayer films, recyclable films and thermoformed components (e.g., packaging component, packaging), such as cups or trays formed from the films. The thermoformed components include polymer combinations that may be recovered regardless of volume or size, for example, in a wash-sink-float-separation process (e.g., hot wash process, warm water wash process, caustic wash process) and further recycled.

In an embodiment, a thermoformable multilayer film comprises a first film comprising a first thermoformable polymer and a second film comprising a first dissolvable layer and a first barrier layer. The first thermoformable polymer comprises a density from 0.88 g/cm³ to 1.40 g/cm³. The first dissolvable layer comprises a saponified ethylene-vinyl ester copolymer. The first barrier layer comprises a barrier polymer. The first film comprises a first surface and a second surface. The first surface comprises an exposed surface of the thermoformable multilayer film. The first dissolvable layer is positioned between the second surface and the first barrier layer.

Other features that may be used individually or in combination with respect to the embodiment are as follows.

The thermoformable polymer further may comprise a melting point from 225° C. to 255° C.

The average density of the first barrier layer may be less than the density of the first thermoformable polymer.

The first dissolvable layer may comprise ethylene-vinyl acetate copolymer (EVA) in an amount from 1% to 75% by weight of the first dissolvable layer.

The first barrier polymer may comprise ethylene vinyl alcohol copolymer (EVOH).

The first film may comprise an extrusion coated film.

The first film may comprise a multilayer film.

The second film may be a coextruded film.

A package comprising the thermoformable multilayer film according to any individual feature or combination of features with respect to the embodiment. The package may comprise a product. The product may comprise a moisture content from 30% to 100% by weight of the product.

In another embodiment, a recyclable film comprises a first region, a second region and a third region. The first region comprises greater than 95% of a single polymer. The second region comprises a saponified ethylene-vinyl ester copolymer. The third region comprises a barrier polymer. The first region comprises an exposed surface of the recyclable film. The first region and the second region are connected to each other.

Other features that may be used individually or in combination with respect to the embodiment are as follows.

The first region and the second region may be connected directly to each other.

A primer layer may be positioned between the first region and the second region.

The recyclable film further may comprise a coextruded multilayer film comprising the first region, the second region and the third region.

The recyclable film may comprise a coextruded multilayer film comprising the second region and the third region.

The first region single polymer may comprise a recyclable polymer.

The first region may comprise a density from 1.23 g/cm³ to 1.38 g/cm³ and the third region comprises a density less than the first region density.

The first region may comprise a density from 0.895 g/cm³ to 0.92 g/cm³ and the third region may comprise a density less than the first region density.

The second region may comprise ethylene-vinyl acetate copolymer (EVA) in an amount from 1% to 75% by weight of the second region.

The third region may comprise a pigment.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional view of an embodiment of a thermoformable multilayer film;

FIG. 2 illustrates a schematic cross-sectional view of an embodiment of a thermoformable multilayer film;

FIGS. 3A-3B illustrate schematic cross-sectional views of embodiments of a thermoformable multilayer film that include a primer layer;

FIG. 4 illustrates a schematic cross-sectional view of an embodiment of a recyclable film;

FIG. 5 illustrates a schematic cross-sectional view of an embodiment of a recyclable film;

FIG. 6 illustrates a schematic perspective view of an embodiment of a thermoformed component;

FIG. 7 illustrates a schematic perspective view of an embodiment of a thermoformed component;

FIG. 8 illustrates a schematic perspective view of an embodiment of a thermoformed component; and

FIG. 9 illustrates a schematic perspective view of an embodiment of a thermoformed component.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are thermoformable multilayer films, recyclable films and thermoformed components that are suitable for packaging products that might be sensitive to oxygen and/or moisture. Barrier materials are included in the film and component structures to prevent the ingress of oxygen and/or moisture. A lidding film may be heat sealed to a thermoformed component made from the thermoformable film or the recyclable film, creating a package that contains a product. Suitable products may be, but are not limited to, fresh food, refrigerated foods, shelf-stable foods, pharmaceuticals, nutraceuticals, medical products, consumer goods, cosmetics, and chemicals. The product includes a moisture content from 0% to 100% by weight of the product. The term “moisture content”, as used herein, refers to the weight of the water contained in a product and is expressed as a percentage of the product weight. A moisture content of 0% indicates that the product is completely dry and 100% indicates that the product is completely saturated (i.e., all liquid).

The packages described herein incorporate at least two packaging components in order to contain products. One component is a thermoformed component, formed from the thermoformable films and recyclable films described herein. The other component may be a lid component. The other component or lidding material is configured from a film or materials that are capable of being hermetically heat sealed to the thermoformed component, producing a protective package for the product. The lidding material may be combined with the thermoformed components in a variety of ways including, but not limited to, heat sealing, gluing or welding.

The thermoformable films, recyclable films and thermoformed components can advantageously be processed to recover the thermoformable polymer without contamination from the barrier material polymers. The thermoformable films, recyclable films and thermoformed components can be introduced into a wash-sink-float separation process where the thermoformable polymer or the recyclable single polymer is separated from the barrier material polymers. The wash-sink-float separation process generally includes the thermoformable films, recyclable films and thermoformed components to be flaked or granulated (e.g., cut into small pieces) and washed in an aqueous detergent solution that allows the thermoformable polymer or recyclable single polymer and the barrier materials to be separated from each other. The flaked thermoformable polymer or recyclable single polymer is recovered from the process and can be reused, e.g., recycled.

The thermoformable films, recyclable films and thermoformed components have the distinct advantage of recyclability in a single polymer recycling stream (e.g., polyester, polypropylene). This advantage is achieved while maintaining good barrier and package integrity.

### Thermoformable Multilayer Film

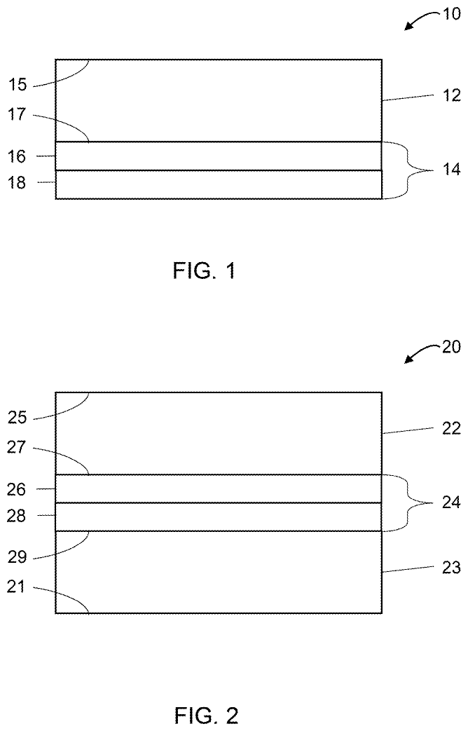

A thermoformable multilayer film 10, shown in FIG. 1, includes at least a first film 12 and a second film 14. The thermoformable multilayer film 10 includes the first film 12 that includes a thermoformable polymer. The second film 14 includes at least a first dissolvable layer 16 and a first barrier layer 18. The first film 12 includes a first surface 15 that includes an exposed surface of the thermoformable multilayer film 10 and a second surface 17. The first dissolvable layer 16 is positioned between the second surface 17 of the first film 12 and the first barrier layer 16 of the second film 14. The positioning and composition of the first dissolvable 16 layer allows the first film 12 to separate from the first barrier layer 18, for example, in a wash-sink-float separation process, where the thermoformable polymer can be recovered and recycled.

The term “thermoformable polymer”, as used herein, refers to polymers that when heated above a minimum temperature will soften to a point where they can be physically formed into a desired shape, and when heated below a maximum temperature, the polymer melts and cannot be web processed.

As used herein, the term “film” is a monolayer or multilayer web that has an insignificant z-direction dimension (thickness) as compared to the x- and y-direction dimensions (length and width). Films are generally regarded as having two major surfaces, opposite each other, expanding in the length and width directions. The surface of the film that is not connected to another layer or film is an exposed surface of the film. Films may be built from an unlimited number of films and/or layers, the films and/or layers being bonded together to form a multilayer film.

The term “layer”, as used herein, refers to a building block of films that is a structure of a single polymer or a homogeneous blend of materials. A layer may contain other non-polymeric materials and may have additives. Layers may be continuous or discontinuous (i.e., patterned) with the length and width of the film. In a monolayer film, “film”, “sheet” and “layer” are synonymous.

The term “multilayer”, as used herein, refers to a single film structure, which may have a plurality of layers, generally in the form of a sheet or web that can be made from a polymeric material or a non-polymeric material bonded together by any conventional means known in the art, (i.e., coextrusion, lamination, coating or a combination thereof).

The first film of the thermoformable multilayer film contains a first thermoformable polymer. The first thermoformable polymer includes a density from 0.88 g.cm³ to 1.40 g/cm³ as measured according to ASTM D792-98. Some thermoformable polymers that include densities within this range include polystyrene, polyester, polypropylene, polyethylene and blends thereof. Examples include, but are not limited to, high impact polystyrene (HIPS), polyethylene terephthalate (PET), amorphous polyethylene terephthalate (APET), glycol-modified polyethylene terephthalate (PETG), polypropylene (PP) homopolymer, and polypropylene copolymer. In some embodiments, the first thermoformable polymer is selected upon compatibility with a single polymer recycling stream or process. In some embodiments, the first thermoformable polymer is selected for aesthetics, rigidity, or abuse resistance of a package resulting from the thermoformable multilayer film. In an embodiment, the first thermoformable polymer includes a polypropylene including a density from 0.895 g/cm³ to 0.92 g/cm³. In another embodiment, the first thermoformable polymer is a polyester including a density from 1.23 g/cm³ to 1.37 g/cm³.

The first thermoformable polymer may include a melting point from 130° C. to 255° C. (266° F. to 491° F.). In an embodiment, the first thermoformable polymer may include a melting point from 130° C. to 225° C. (266° F. to 437° F.) In an embodiment, the first thermoformable polymer includes a polyester that includes a melting point from 225° C. to 255° C. (437° F. to 491° F.).

As used throughout this application, the terms “polystyrene” or “PS” or “styrenic based polymers” refer to a homopolymer or copolymer having at least one styrene monomer linkage (such as benzene (i.e., C₆H₅) having an ethylene substituent) within the repeating backbone of the polymer. The styrene linkage can be represented by the general formula: [CH₂—CH₂ (C₆H₅)]ₙ.

As used throughout this application, the term “polyester” refers to a homopolymer or copolymer having an ester linkage between monomer units which may be formed, for example, by condensation polymerization reactions between a dicarboxylic acid and a diol. The ester linkage can be represented by the general formula: [O—R—OC(O)—R′—C(O)] n where R and R′ are the same or different alkyl (or aryl) group and may be generally formed from the polymerization of dicarboxylic acid and diol monomers containing both carboxylic acid and hydroxyl moieties. The dicarboxylic acid (including the carboxylic acid moieties) may be linear or aliphatic (e.g., lactic acid, oxalic acid, maleic acid, succinic acid, glutaric acid, adipic acid, pimelic acid, suberic acid, azelaic acid, sebacic acid, and the like) or may be aromatic or alkyl substituted aromatic (e.g., various isomers of phthalic acid, such as paraphthalic acid (or terephthalic acid), isophthalic acid and naphthalic acid). Specific examples of a useful diol include but are not limited to ethylene glycol, propylene glycol, trimethylene glycol, 1,4-butane diol, neopentyl glycol, cyclohexane diol and the like. Polyesters may include a homopolymer or copolymer of alkyl-aromatic esters including but not limited to polyethylene terephthalate (PET), amorphous polyethylene terephthalate (APET), crystalline polyethylene terephthalate (CPET), glycol-modified polyethylene terephthalate (PETG) and polybutylene terephthalate; a copolymer of terephthalate and isophthalate including but not limited to polyethylene terephthalate/isophthalate copolymer; a homopolymer or copolymer of aliphatic esters including but not limited to polylactic acid (PLA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); and blends of any of these materials.

As used throughout this application, the term “copolymer” refers to a polymer product obtained by the polymerization reaction or copolymerization of at least two monomer species. Copolymers may also be referred to as bipolymers. The term “copolymer” is also inclusive of the polymerization reaction of three, four or more monomer species having reaction products referred to terpolymers, quaterpolymers, etc.

As used throughout this application, the term “modified” refers to a chemical derivative, such as one having any form of anhydride functionality (e.g., anhydride of maleic acid, crotonic acid, citraconic acid, itaconic acid, fumaric acid, etc.), whether grafted onto a polymer, copolymerized with a polymer or blended with one or more polymers. The term is also inclusive of derivatives of such functionalities, such as acids, esters and metal salts derived from such.

As used throughout this application, the term “polypropylene” or “PP” refers to a homopolymer or copolymer having at least one propylene monomer linkage within the repeating backbone of the polymer. The propylene linkage can be represented by the general formula: [CH₂—CH(CH₃)]ₙ.

As used throughout this application, the term “polyethylene” or “PE” refers (unless indicated otherwise) to ethylene homopolymers as well as copolymers of ethylene with at least one alpha-olefin. The term will be used without regard to the presence or absence of substituent branch groups.

The first film 12 may be a monolayer film, as shown in FIG. 1, or a multilayer film. In an embodiment, the first film may be an extrusion coated film. In another embodiment, the first film may be a coextruded multilayer film. In some embodiments, the first film is a blown film. The term “blown film”, as used herein refers to a film produced by the blown coextrusion process. In the blown coextrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel, and then rapidly cooled or quenched by any of various methods known to those of skill in the art.

The multilayer film may be produced as a blown film which is subsequently collapsed and bonded to itself. The material comprising the inner surface of the tubular extrudate may be chosen such that upon collapsing the tube, the film is combined into a single web. The material comprising the inner surface of the tubular extrudate becomes the core layer of the multilayer film. The material comprising the core layer of the multilayer film may be, but is not limited to, an ethylene-vinyl acetate copolymer (EVA).

The multilayer film includes as many layers as desired and, preferably, at least two layers. In multilayer films that include at least three layers, the film includes an inner layer. As used throughout this application, the term “inner layer” refers to a layer that is positioned between two other layers. As used throughout this application, the term “surface layer” refers to a layer that does not have another layer on at least one of the major surfaces, (i.e., a surface layer is on the exterior of the multilayer film).

With reference to FIG. 2, in some embodiments, the thermoformable multilayer film 20 may include a second first film 23. The second first film 23 may have the same composition or differ from the composition of the first film 22. The second first film 23 includes a first surface 21 that includes a second exposed surface of the thermoformable multilayer film 20 and a second surface 29. The first film 22 includes a first surface 25 that includes an exposed surface of the thermoformable multilayer film and a second surface 27.

The thermoformable multilayer film 20 further includes the second film 24 that is a multilayer film that includes the first dissolvable layer 26 and the first barrier layer 28. The second film 24 is a multilayer film that may include as many layers as desired in addition to the first dissolvable layer 26 and the first barrier layer 28.

In any embodiment, the first dissolvable layer is positioned between the first film and the first barrier layer. The second film that includes the first dissolvable layer and the first barrier layer is uniquely configured to provide proper barrier to product contained within a package resulting from the thermoformable multilayer film and allow for separation of the first film and the first barrier layer. The first dissolvable layer facilitates good bond strength between the first film and the first barrier layer and yet can partially or completely dissolve in a wash-sink-float-separation process. That is, the thermoformable multilayer film, or resulting thermoformed components, advantageously provide barrier and can contain high moisture content products without separation between the first and second films until subjected to a separation process. The second film may contain multiple dissolvable layers, that is, a second dissolvable layer, a third dissolvable layer and so on.

The first dissolvable layer includes a saponified ethylene-vinyl ester copolymer. Saponified ethylene-vinyl ester copolymers of this disclosure include water soluble polymers that include butene-diol vinyl alcohol copolymer (BVOH), polyvinyl alcohol copolymer (PVOH), modified polyvinyl alcohol copolymer (mPVOH), ethylene vinyl alcohol copolymer (EVOH) and other similar materials. Non-limiting examples of saponified ethylene-vinyl ester copolymer include modified EVOH available under the trade name of MICHEM FLEX from Michelman, Inc. (Cincinnati, OH, USA), polyvinyl alcohol-based polymers available under the trade name of MOWIFLEX, EXCEVAL or POVAL from Kuraray America, Inc, (Houston, TX, USA) and butene-diol vinyl alcohol copolymer-based polymers available under the trade name of NICHIGO G-POLYMER (acetic acid ethenyl ester, polymer with ethene and 1,1′-(1-ethenyl-1,2-ethanediyl)diacetate, hydrolyzed). Non-limiting NICHIGO G-POLYMER grades include BVE8049P and OKS-8095P from Soarus LLC (Arlington Heights, IL, USA). The saponified ethylene-vinyl ester copolymer may be present in the first dissolvable layer in an amount from 25% to 100% by weight of the first dissolvable layer and including any range or combination of ranges therein. In an embodiment, the saponified ethylene-vinyl ester copolymer may be present in the first dissolvable layer in an amount from 25% to 90%, 35% to 80%, 45% to 70%, and 55% to 65% by weight of the first dissolvable layer.

As previously discussed, the first dissolvable layer facilitates bonding between the first film and the first barrier layer. The first dissolvable layer functionality may be enhanced by blending saponified ethylene-vinyl ester copolymers with an ethylene-vinyl acetate copolymer (EVA). As used throughout this application, the terms “ethylene-vinyl acetate” and “EVA” refer to copolymers comprised of repeating units of ethylene and vinyl acetate. Ethylene-vinyl acetate copolymers may be represented by the general formula: [(CH₂—CH₂)ₙ—(CH₂—CH(COO)(CH₃)]ₙ. The vinyl acetate content may vary from less than 10% to greater than 95% by weight of total EVA composition. The vinyl acetate content of EVA for packaging applications may vary from 5% to 40% by weight. EVA may be present in the first dissolvable layer in an amount from 1% to 75% by weight of the first dissolvable layer and including any range or combination of ranges therein. In an embodiment, the EVA may be present in an amount from greater than 30%, 35%, 40%, 45%, 50%, 55%, 60%, 65%, and 70%, and including or less than 75% by weight of the first dissolvable layer. In an embodiment, the EVA may be present in an amount from 35% to 55% by weight of the first dissolvable layer. In an embodiment, the EVA may be present in an amount from greater than 55% to 75% by weight of the first dissolvable layer.

The balance of the first dissolvable layer may include a polyethylene, for example, HDPE. In an embodiment, the first dissolvable layer may include 100% saponified ethylene-vinyl ester copolymer by weight of the first dissolvable layer. In another embodiment, the first dissolvable layer may include 75% saponified ethylene-vinyl ester copolymer, 20% EVA and 5% polyethylene by weight of the first dissolvable layer. In a further embodiment, the first dissolvable layer may include 65% saponified ethylene-vinyl ester copolymer, 35% EVA and 5% polyethylene by weight of the first dissolvable layer. In yet another embodiment, the first dissolvable layer may include 40% saponified ethylene-vinyl ester copolymer, 55% EVA and 5% polyethylene by weight of the first dissolvable layer.

The second film includes a first barrier layer that includes a barrier polymer. The term “barrier layer”, as used herein, refers to a layer that significantly reduces the transmission of molecular species through the layer. A barrier layer may be a surface layer or an inner layer of the second film. A barrier layer may limit or reduce the permeation of migratory species such as moisture, oxygen or other gasses. Barrier layers are typically comprised of metals or polymers that are referred to as “barrier materials”. Barrier materials useful for thermoformable films and thermoformed components include, but are not limited to, ethylene vinyl alcohol copolymer (EVOH), PVDC, high density polyethylene (HDPE), cyclic olefin copolymers (COC), polyamides, polyacrylates and metal oxides. Barrier layers may comprise blends of materials. The second film may contain multiple barrier layers, that is, a second barrier layer, a third barrier layer and so on. The second film may further contain additional layers to provide bulk or adhesion among other things.

In some embodiments of the second film, the barrier layer includes an ethylene vinyl alcohol copolymer. The terms “ethylene vinyl alcohol copolymer” or “EVOH”, as used herein, refer to copolymers comprised of repeating units of ethylene and vinyl alcohol. Ethylene vinyl alcohol copolymers can be represented by the general formula: [(CH₂—CH₂)ₘ—(CH₂—CH(OH))]ₙ. Preferably, ethylene vinyl alcohol copolymers comprise from about 28 mole percent to about 48 mole percent ethylene. The type of EVOH may be selected to be one of the grades especially designed for thermoforming applications, as are known in the art. An example of a thermoformable EVOH is Soarnol™ ET3803 (38 mol % ethylene content) available from Soarus L.L.C. EVOH is known to reduce the permeation of oxygen and other gasses through polymeric based packaging films. EVOH includes a density from 0.93 g/cm³ to 0.97 g/cm³.

The first barrier layer may provide other barrier such as moisture barrier. Some embodiments of the first barrier layer may include high density polyethylene (HDPE) for moisture barrier improvements. The terms “high density polyethylene” or “HDPE”, as used herein, refer to both (a) homopolymers of ethylene which have densities from about 0.960 g/cm³ to about 0.970 g/cm³ and (b) copolymers of ethylene and an alpha-olefin (usually 1-butene or 1-hexene) which have densities from about 0.940 g/cm³ to about 0.958 g/cm³. HDPE includes polymers made with Ziegler or Phillips type catalysts and polymers made with single-site metallocene catalysts. HDPE also includes high molecular weight “polyethylenes.” In contrast to HDPE, whose polymer chain has some branching, are “ultra high molecular weight polyethylenes,” which are essentially unbranched specialty polymers having a much higher molecular weight than the high molecular weight HDPE. HDPE includes a density from 1.12 g/cm³ to 1.24 g/cm³. The second film may comprise one, two, three, four or more separate layers comprising HDPE, each consisting essentially of HDPE. That is, the HDPE may be accompanied by other minor components such as slip, antiblock, processing aid, nucleation additives, or hydrocarbon additives, such that the blend consists of at least 80% HDPE.

The thermoformable multilayer film may have an oxygen transmission rate, when an oxygen barrier material such as EVOH is included in the thermoformable multilayer film composition, of less than 1.5 cc/m²/24 hours, or between 0.031 cc/m²/24 hours and 1.5 cc/m²/24 hours, between 0.5 cc/m²/24 hours and 1.0 cc/m²/24 hours and including any range or combination of ranges therein, where cc is cubic centimeters, when measured at 23° C. and 0% relative humidity (RH) using ASTM D3985. The thermoformable multilayer film may have an oxygen transmission rate of less than 1.5 cc/m²/24 hours, or between 0.100 cc/m²/24 hours and 1.5 cc/m²/24 hours, between 0.5 cc/m²/24 hours and 1.0 cc/m²/24 hours and including any range or combination of ranges therein, where cc is cubic centimeters, when measured at 23° C. and 50% RHₒᵤₜ-80% RHᵢₙ using ASTM D3985. Without an oxygen barrier material such as EVOH, the thermoformable multilayer film may include an oxygen transmission rate from 200 cc/m²/24 hours to 900 cc/m²/24 hours.

The thermoformable multilayer film may have a moisture transmission rate, when a moisture barrier material such as HDPE is included in the thermoformable multilayer film compositions of less than 5.0 g/m²/24 hours, or between 0.3 g/m²/24 hours and 5.0 g/m²/24 hours, and including any range or combination of ranges therein when measured at 38° C. and 90% RH using ASTM F1249.

The second film may include a pigment within the polymer layers comprising the second film, (i.e., the first dissolvable layer, the first barrier layer). Pigment is often included in the structure to produce colored components or components that require light blocking. In some instances, the pigmented second film provides optical detection in a wash-sink-float-separation process. The layer or layers including the pigment may be located centrally to the thermoformable multilayer film structure. In this context, the term “centrally” is meant to indicate that the pigment is near the center of the structure, but not necessarily at exactly the center of the structure. In an embodiment, the first barrier layer includes the pigment. In another embodiment, the first barrier layer including HDPE includes the pigment.

Other inner layers of the second film may comprise any materials known to be compatible and useful to thermoformable packaging. Inner layers may be functional. For example, inner layers may provide barrier (barrier materials), adhesion (adhesive or tie materials), thermoforming stability, and any other functions known to be useful for multilayer films.

As used throughout this application, the term “tie material” refers to a polymeric material serving a primary purpose or function of adhering two surfaces to one another, typically the planar surfaces of two film layers. A tie material adheres one film layer surface to another film layer surface. The tie material may comprise any polymer, copolymer or blend of polymers having a polar group or any other polymer, homopolymer, copolymer or blend of polymers, including modified and unmodified polymers (such as grafted copolymers), which provide sufficient interlayer adhesion to adjacent layers comprising otherwise non-adhering polymers.

In some embodiments, the second film is a coextruded multilayer film where the first dissolvable layer comprises a surface layer of the second film such as the second film that is subsequently connected to the first film as shown in FIGS. 1 and 2. In other embodiments, the second film is a coextruded multilayer film where the first dissolvable layer comprises an inner layer. In this embodiment, the surface layer of the second film may include a thermoformable polymer.

In another embodiment, the thermoformable multilayer film includes a first film including a first thermoformable polymer of polyester. The second film includes, in sequential order, a surface layer of polyester, a first dissolvable layer including a saponified ethylene-vinyl ester copolymer, a tie layer, and a first barrier layer comprising a barrier polymer.

In a further embodiment, the thermoformable multilayer film includes a first film including a first thermoformable polymer of polyester. The second film includes, in sequential order, a surface layer that is a first dissolvable layer including a saponified ethylene-vinyl ester copolymer, a tie layer, and a first barrier layer comprising a barrier polymer.

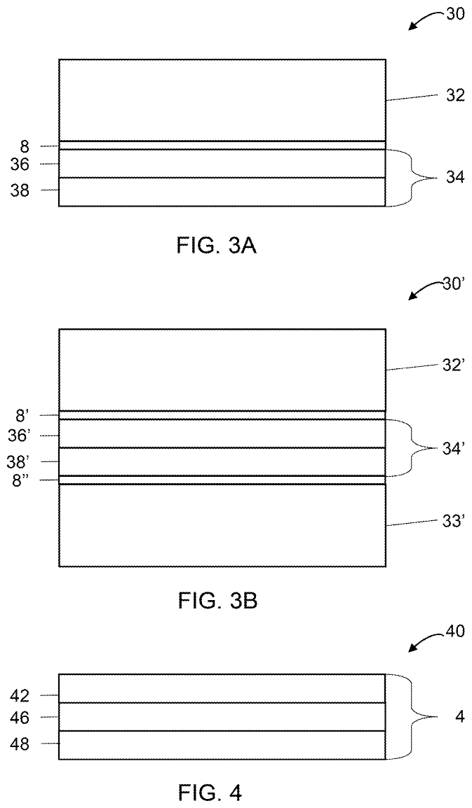

The first film may be connected directly to the second film. In an embodiment, the first film may be extrusion coated onto the second film. In other embodiments, a primer layer may be applied to an outer surface of the second film before it is connected to the first film and before the second film is connected to the first film. With reference to FIG. 3A, a thermoformable multilayer film 30 that includes a primer layer 8 is shown. The primer layer 8 is positioned between the first dissolvable layer 36 and the first film 32. The primer layer 8 is believed to improve the bond strength between the first film 32 and the second film 34 that includes the first dissolvable layer 36 and the first barrier layer 38. With reference to FIG. 3B, a thermoformable multilayer film 30′ is shown. The thermoformable multilayer film 30′ includes a second first film 33′, a first primer layer 8′ and a second primer layer 8″. The first primer layer 8′ is positioned between the first dissolvable layer 36′ and the first film 32′. The second primer layer 8″ is positioned between the first barrier layer 38′ and the second first film 33′.

The primer layer(s) may be applied by any manner known by one of skill in the art. An exemplary primer layer includes a two-component system that includes a water-based adhesive and a coreactant. A suitable primer layer system includes grades under the trade name of ROBOND of L-330 (water-based adhesive) and CR 9-101 (coreactant) that available from Dow Chemical Company (Houston, TX, USA).

The thermoformable multilayer films described herein may be recycled after their primary use is completed. The term “suitable for recycling”, as used herein, is meant to indicate that the film can be converted into a new, useful item by means of reprocessing in a recycle stream (e.g., recycling streams based on the first thermoformable polymer or single polymer). Reprocessing may entail washing, separating, melting and forming, among many other steps. Typically, when plastic packaging is recycled by reprocessing, the material is mechanically chopped into small pieces (e.g., granulated, flaked, etc.), melted, mixed and reformed into the new product. If multiple incompatible materials are present in the packaging, interactions occur during reprocessing causing gels, brittle material, poor appearance, and generally unusable or poor quality products. Using the term “recyclable” indicates that these drawbacks generally are not present. Qualification as a recyclable material is not regulated by any specific agencies but can be obtained from groups such as the Association of Plastic Recyclers (APR) and How2Recycle™.

The first thermoformable polymer of the thermoformable multilayer film may be recovered in a wash-sink-float-separation process that allows the first thermoformable polymer to be recycled. A wash-sink-float-separation process prescribes the thermoformable multilayer film to be granulated (e.g., flaked, cut into small pieces, etc.) and subjected to the wash step of the process. The first dissolvable layer partially (e.g., when dissolvable layer includes less than 100% of saponified ethylene-vinyl ester copolymer) or completely dissolves (e.g., when dissolvable layer includes 100% saponified ethylene-vinyl ester copolymer) in the wash step of the process. The dissolvability of the first dissolvable layer allows the granulated first film including the thermoformable polymer to sink and the granulated first barrier layer to float. The granulated first barrier layer may include a portion of the granulated dissolvable layer if the dissolvable layer did not completely dissolve. In an embodiment, the average density of the first barrier layer is less than the density of the first thermoformable polymer. In an embodiment, the first film includes a first thermoformable polymer including polyester having a density from 1.23 g/cm³ to 1.37 g/cm³ and the second film includes a first barrier layer comprising an average density lower than that of polyester. In another embodiment, the first film includes a first thermoformable polymer including polypropylene having a density from 0.895 g/cm³ to 0.92 g/cm³ and the second film comprises a first barrier layer comprising an average density lower than that of polypropylene. A granulating and wash-sink-float-separation process for the recovery of PET is described in a protocol according to the Association of Plastic Recyclers in Document Number PET-P-00, dated Sep. 17, 2019, steps PET-P-01 through PET-P-04 (pages 3-12).

The first film that includes the first thermoformable polymer should be thick enough to contribute significant stiffness to a thermoformed component. The required thickness of the thermoformed component may be dependent on the type of material used in the first film. For example, polyester or polystyrene-based polymers may thermoform easily and evenly thus requiring less thickness to create an acceptable final part with stiffness appropriate for use. In general, the overall thickness of the first film should be from 76 microns (3 mil) to 2,540 microns (100 mil) or any thickness therebetween. In some embodiments, the first film thickness is greater than 254 microns (10 mil), greater than 381 microns (15 mil), or greater than 508 microns (20 mil). In other embodiments the first film thickness is between 152 microns (6 mil) and 1,270 microns (50 mil). In some other embodiments the first film thickness is between 254 microns (10 mil) and 1,016 microns (40 mil). In embodiments where the thermoformable multilayer film includes a second first film, the second first film may be identical or different in structure, composition and thickness as the first film. The thickness of each the first film and second first film may be nearly the same. The ratio of the thickness of the first film and the thickness of the second first film may be between 2:1 and 1:2. In some embodiments the ratio of the thicknesses is 1:1.

The thickness of the second film that includes the dissolvable layer and the first barrier layer may have a thickness of less than 127 microns (5 mil). The second film may have a thickness between 25.4 microns (1 mil) and 200 microns (7.8 mil) and more particularly from 76 microns (3 mil) to 140 microns (5.5 mil).

### Recyclable Film

The embodiments disclosed herein include a recyclable film. The recyclable film includes a first region, a second region and a third region. The first region includes greater than 95% of a single polymer. The second region includes a saponified ethylene-vinyl ester copolymer. The third region includes a barrier polymer. The first region includes an exposed surface of the recyclable film and the first region and the second region are connected to each other.

The positioning and composition of the second region allows the first region to separate from the third region, for example, in a wash-sink-float separation process, where the single polymer can be recovered and recycled. Recyclable films disclosed herein may be suitable for single polymer recycling streams, such as polyester or polypropylene. Introduction of the recovered portion of the recyclable film into any of these recycling-by-reprocessing avenues may not require additional compatibilizer.

Being suitable for recycling may be obtained by keeping the overall amount of the single polymer in the first region at a high level. Any additives used should be kept to a minimum. Any non-single polymers present should be minimized. The total composition of the first region may include between 90% and 100% of a single polymer by weight including any range or combination of ranges therein. In some embodiments, the total composition of the first region is greater than 90%, or greater than 95% of a single polymer by weight. In an embodiment, the single polymer is present in an amount from 95% to 100% of the first region by weight.

The single polymer of the first region may be selected from any of those previously described that may be used as the thermoformable polymer of the thermoformable multilayer film of this disclosure. The single polymer can be carefully selected based on its capability to be recycled in a single polymer stream, i.e., recyclable polymer. The first region may include a thickness such as described for the first film of the thermoformable multilayer film.

The saponified ethylene-vinyl ester copolymer of the second region may be selected from the saponified ethylene-vinyl ester copolymer described herein that may be used for the dissolvable layer of the thermoformable multilayer film second film. The second region may further include EVA in an amount from 1% to 75% by weight of the second region including any range or combination or ranges therein.

The third region may include an oxygen barrier material, a moisture barrier or a combination thereof. Suitable barrier materials that may be used for the third region include those as previously described as being suitable materials for the first barrier layer of the second film of the thermoformable multilayer film.

The third region may include a pigment. The pigment may be included as previously described for the second film of the thermoformable multilayer film.

The recyclable film 40, shown in FIG. 4, may be a coextruded multilayer film 4. That is, the first region 42, the second region 46 and the third region 48 may be a multilayer film that comprises the recyclable film 40.

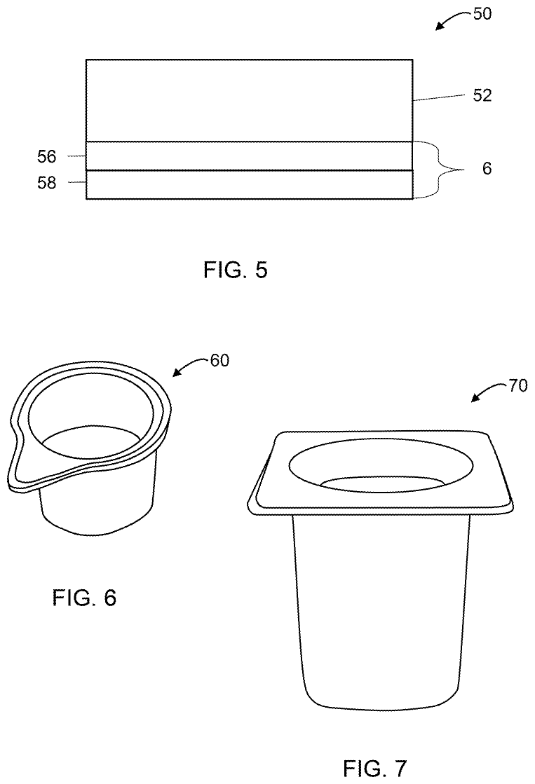

In other embodiments, with reference to FIG. 5, the recyclable film 50 includes the second region 56 and the third region 58 to be a coextruded multilayer film 6, where the first region 52 is subsequently extrusion coated, laminated or connected to the coextruded multilayer film 6 that includes the second region 56 and the third region 58. In some embodiments, the first region 52 and the second region 56 are connected directly to each other.

In some other embodiments, at least one layer may be positioned between the first region and the second region. The at least one layer may include a primer layer such as previously described for use in the thermoformable multilayer film between the first film and the dissolvable layer. The first region and the second region may be laminated by heat, extrusion or adhesive. For example, the adhesive layer of the recyclable film may include a one-or two-component laminating adhesive. These adhesives typically use polyurethane, acrylic, or epoxy amine type chemistry.

The single polymer of the first region of the recyclable film may be recovered in a wash-sink-float-separation process that allows the single polymer to be recycled. The second region partially (e.g., when second region includes less than 100% of saponified ethylene-vinyl ester copolymer) or completely dissolves (e.g., when second region includes 100% saponified ethylene-vinyl ester copolymer) in the wash step of the process. The dissolvability of the second region allows the granulated first region including the single polymer to sink and the granulated third region to float. The granulated third region may include a portion of the granulated second region if the second region did not completely dissolve. In an embodiment, the density of the third region is less than the density of the first region. In an embodiment, the first region includes a single polymer including a density from 1.23 g/cm³ to 1.38 g/cm³ and the third region includes a density lower than that of the first region. In another embodiment, the first region includes a single polymer including a density from 0.895 g/cm³ to 0.92 g/cm³ and the third region includes a density lower than that of the first region. A granulating and wash-sink-float-separation process may be utilized for the recovery of the single polymer.

The first region includes a thickness that may correspond to that previously described for the first film of the thermoformable multilayer film. In other embodiments, such as when the first region is included in the same multilayer film as the second region and the third region, the first region thickness may be from 2.54 microns (0.1 mil) to 101.6 microns (4 mil) including any range or combination of ranges therein. The first region may have a thickness less than 25.4 microns (1 mil). The first region thickness may be between 5.8 microns (0.2 mil) and 12.7 microns (0.5 mil).

The second region includes a thickness from 2.54 microns (0.1 mil) to 101.6 microns (4 mil) including any range or combination of ranges therein. The second region may have a thickness less than 25.4 microns (1 mil). The second region thickness may be between 5.8 microns (0.2 mil) and 12.7 microns (0.5 mil).

The third region includes a thickness from 2.54 microns (0.1 mil) to 101.6 microns (4 mil) including any range or combination of ranges therein. The third region may have a thickness less than 25.4 microns (1 mil). The third region thickness may be between 5.8 microns (0.2 mil) and 12.7 microns (0.5 mil).

In an embodiment, the second region and the third region are layers within a multilayer film and the first region is an extrusion coated film of the recyclable film. The recyclable film has a thickness of 432 microns (17 mil). The first region includes a thickness of 343 microns (13.5 mil). The second region includes a thickness of 13 microns (0.5 mil). The third region includes a thickness of 76 microns (3 mil).

In another embodiment, the second region and the third region are layers within a multilayer film and the first region is an extrusion coated film of the recyclable film. The recyclable film has a thickness of 432 microns (17 mil). The first region includes a thickness of 171 microns (6.75 mil). The second region includes a thickness of 13 microns (0.5 mil). The third region includes a thickness of 248 microns (9.75 mil).

In a further embodiment, the second region and the third region are layers within a multilayer film and the first region is an extrusion coated film of the recyclable film. The recyclable film has a thickness of 432 microns (17 mil). The first region includes a thickness of 140 microns (5.5 mil). The second region includes a thickness of 13 microns (0.5 mil). The third region includes a thickness of 279 microns (11 mil).

Accordingly, in each of the aforementioned embodiments, the second region is 3% of the recyclable film by weight. It was surprisingly found that the small portion of the recyclable film structure that is the second region can provide adequate interlaminar bond strength of the first region to the third region and contain high moisture content product without dissolution. The term “dissolution”, as used herein, refers to the separation of layers or films from each other that do not include saponified ethylene-vinyl ester copolymer where the separation is due to the partial or complete dissolvability of a saponified ethylene-vinyl ester copolymer-containing layer or film that is between the layers or films that do not include saponified ethylene-vinyl ester copolymer.

### Thermoformed Component and Packaged Product

The thermoformable and recyclable films disclosed herein can undergo a thermoforming process to form a thermoformed component of a package. Thermoforming is a process by which a film is permanently formed into a desired shape by the application of a differential pressure between the sheet and a mold, by the application of heat, by the combination of heat and the application of a differential pressure between the film or sheet and a mold, or by any thermoforming technique known to those skilled in the art. Thermoformed components may have one or more compartments and may take a wide variety of shapes and designs. The thermoformed component may include another component (e.g., lidding material, another thermoformed component, etc.) to form a package that contains a product.

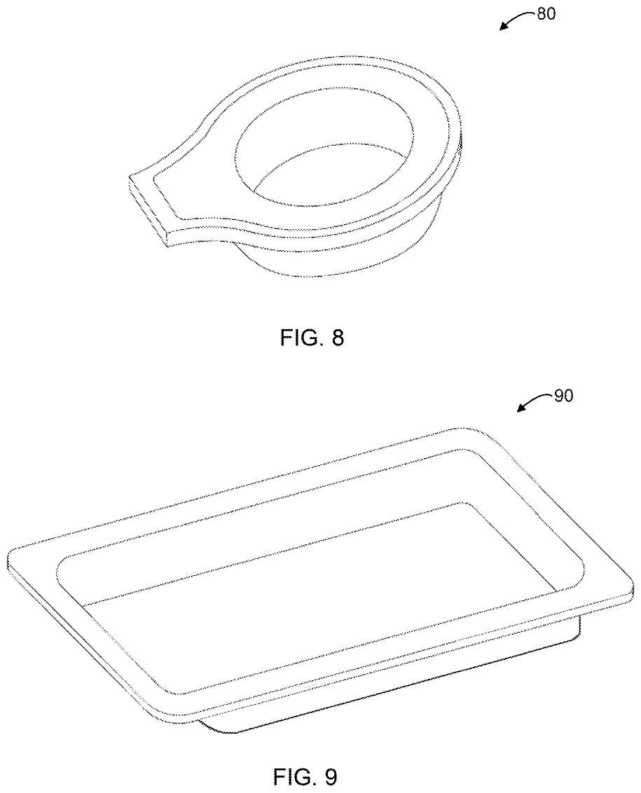

Non-limiting examples of thermoformed components are shown in FIGS. 6-9. The thermoformed components may contain a variety of products that include moisture contents ranging from 0% to 100% including any range or combination of ranges therein. Thermoformed components formed from the thermoformable multilayer films and recyclable films disclosed herein are well suited to contain products that include a moisture content of greater than 30%. The thermoformed component 60 in FIG. 6 is shown as a liquid creamer cup. The liquid creamer cup may contain products having a moisture content of up to 100% (e.g., juices, gelatin snacks). The thermoformed component 70 in FIG. 7 is shown as a cup that can contain products such as pudding or yogurt that include a moisture content of about 75% to about 85%. The thermoformed components 80 and 90 shown in FIG. 8 and FIG. 9, respectively, are different shaped trays. For example, thermoformed component 80 may contain snacks such as nuts having a moisture content from 1% to 20%, or cheese having a moisture content from 30% to 80%. Thermoformed component 90 may contain meat or poultry having a moisture content from 55% to 75%. In an embodiment, packages including the thermoformed component resulting from the thermoformable multilayer films or recyclable films described herein contain a product including a moisture content of greater than 30%.

### Test Methods

The Association of Plastic Recyclers in Document Number PET-P-00, dated Sep. 17, 2019, steps PET-P-01 through PET-P-04 (pages 3-12 of the protocol document) was used to evaluate the films of the present disclosure.

Materials used for APR detergent wash solution were Triton X-100 nonionic surfactant and sodium hydroxide, NaOH, solution.

### Examples

Sample films were produced according to the general structure shown in FIG. 2. Materials Balance Evaluation PET-S-04 (page 9 of the test described in the Test Methods section of this disclosure) was completed for each sample.

The samples included an overall thickness of 508 microns (20 mil). The samples included two outer films of polyester with each film having a thickness of 210 microns (8.25 mil). Each sample included a multilayer film sandwiched between each of the polyester films having a thickness of 83 microns (3.25 mil). Samples 1-6 included a blown, multilayer film that included saponified ethylene-vinyl ester copolymer (SEVEC) in each of the outer layers of the blown film. The multilayer film of Samples 1-3 included the following structure:

SEVEC/tie/EVOH/tie/HDPE/EVA/HDPE/tie/EVOH/tie/SEVEC

The SEVECs used in the samples were vinyl alcohol copolymer-based polymers available under the trade name of NICHIGO G-POLYMER. The SEVEC-containing layer composition for each sample film is summarized in TABLE 1.

All samples achieved complete separation based on Materials Balance Evaluation, PET-S-04.

TABLE 1

| | SEVEC | EVA | Polyethylene |
|---|---|---|---|
| Film | content, % | content, % | content, % |
| Sample 1 | 100 | 0 | 0 |
| Sample 2 | 75 | 20 | 5 |
| Sample 3 | 65 | 30 | 5 |
| Sample 4 | 55 | 40 | 5 |
| Sample 5 | 45 | 50 | 5 |
| Sample 6 | 35 | 60 | 5 |

Additional sample films were produced that included a primer layer. Materials Balance Evaluation PET-S-04 was completed for each sample.

Sample 7 was constructed similarly to Samples 1-6 with the primer layer positioned between the polyester film and the SEVEC-containing layer of the multilayer film and included the general structure shown in shown in FIG. 3B. Sample 7 included an overall thickness of 508 microns (20 mil), two outer films of polyester with each film having a thickness of 210 microns (8.25 mil).

Sample 8 included the structure shown in shown in FIG. 3A. The sample included the multilayer film of Samples 1-7 with the primer layer positioned between the polyester film and the SEVEC-containing layer of the multilayer film. The sample included an overall thickness of 597 microns (23.5 mil). The sample included a polyester film having a thickness of 508 microns (20 mil).

TABLE 2 includes a summary of the SEVEC-containing layer composition for Samples 7 and 8.

All samples achieved complete separation based on Materials Balance Evaluation, PET-S-04.

TABLE 2

| | SEVEC |
|---|---|
| Film | content, % |
| Sample 7 | 100 |
| Sample 8 | 100 |

1. A thermoformable multilayer film comprising:
a first film comprising a first thermoformable polymer; and
a second film comprising a first dissolvable layer and a first barrier layer;
wherein the first thermoformable polymer comprises a density from 0.88 g/cm³ to 1.40 g/cm³, wherein the first dissolvable layer comprises a saponified ethylene-vinyl ester copolymer, wherein the first barrier layer comprises a barrier polymer, wherein the first film comprises a first surface and a second surface, wherein the first surface comprises an exposed surface of the thermoformable multilayer film, and wherein the first dissolvable layer is positioned between the second surface and the first barrier layer.

2. The thermoformable multilayer film according to claim 1, wherein the thermoformable polymer further comprises a melting point from 225° C. to 255° C.

3. The thermoformable multilayer film according to claim 1, wherein the average density of the first barrier layer is less than the density of the first thermoformable polymer.

4. The thermoformable multilayer film according to claim 1, wherein the first dissolvable layer comprises ethylene vinyl acetate copolymer (EVA) in an amount from 1% to 75% by weight of the first dissolvable layer.

5. The thermoformable multilayer layer according to claim 1, wherein the first barrier polymer comprises high density polyethylene (HDPE).

6. The thermoformable multilayer film according to claim 1, wherein the first barrier polymer comprises ethylene vinyl alcohol copolymer (EVOH).

7. The thermoformable multilayer film according to claim 1, wherein the first film is an extrusion coated film.

8. The thermoformable multilayer film according to claim 1, wherein the first film comprises a multilayer film.

9. The thermoformable multilayer film according to claim 1, wherein the second film is a coextruded film.

10. A package comprising the thermoformable multilayer film according to claim 1 and a product, wherein the product comprises a moisture content from 30% to 100% by weight of the product.

11. A recyclable film comprising:
a first region comprising greater than 95% by weight of a single polymer;
a second region comprising a saponified ethylene-vinyl ester copolymer; and
a third region comprising a barrier polymer;
wherein the first region comprises an exposed surface of the recyclable film, and wherein the first region and the second region are connected to each other.

12. The recyclable film of claim 11, wherein the first region and the second region are connected directly to each other.

13. The recyclable film of claim 11, wherein a primer layer is positioned between the first region and the second region.

14. The recyclable film of claim 11, further comprising a coextruded multilayer film comprising the first region, the second region and the third region.

15. The recyclable film according to claim 11, further comprising a coextruded multilayer film comprising the second region and the third region.

16. The recyclable film according to claim 11, wherein the first region single polymer comprises a recyclable polymer.

17. The recyclable film according to claim 11, wherein the first region comprises a density from 1.23 g/cm³ to 1.38 g/cm³ and the third region comprises a density less than the first region density.

18. The recyclable film according to claim 11, wherein the first region comprises a density from 0.895 g/cm³ to 0.92 g/cm³ and the third region comprises a density less than the first region density.

19. The recyclable film according to claim 11, wherein the second region comprises ethylene vinyl acetate copolymer (EVA) in an amount from 1% to 75% by weight of the second region.

20. The recyclable film according to claim 11, wherein the third region comprises a pigment.
